(19) United States
(12) Patent Application Publication
(10) Pub. No.: US 2024/0275080 A1
(43) Pub. Date: Aug. 15, 2024

(54) FASTENING STRUCTURE AND ALUMINUM WIRING MEMBER

(71) Applicant: Yazaki Corporation, Tokyo (JP)

(72) Inventors: Rie NAKABAYASHI, Shizuoka (JP); Hayato Ikeya, Shizuoka (JP); Mika Tsuboi, Shizuoka (JP); Satoru Yoshinaga, Shizuoka (JP)

(73) Assignee: Yazaki Corporation, Tokyo (JP)

(21) Appl. No.: 18/495,331

(22) Filed: Oct. 26, 2023

Related U.S. Application Data
(63) Continuation of application No. PCT/JP23/03509, filed on Feb. 3, 2023.

(51) Int. Cl. H01R 4/34; F16B 33/00; H01R 4/62

(52) U.S. Cl. CPC H01R 4/34; F16B 33/00; H01R 4/62; F16B 2200/93

(57) ABSTRACT

A fastening structure includes a first fastened member containing pure aluminum or an aluminum alloy, a second fastened member containing metal, and a fastening member that fasten and fix the first fastened member and the second fastened member to each other. A protrusion is integrally formed on a surface of the first fastened member facing the second fastened member, the protrusion containing pure aluminum or an aluminum alloy and protruding toward the second fastened member. The pure aluminum or the aluminum alloy in the protrusion on the first fastened member directly contact and adhere to the metal in the second fastened member. An aluminum wiring member includes the fastening structure.

### CROSS-REFERENCE TO RELATED APPLICATIONS

The present application is a continuation of International Application No. PCT/JP2023/003509, filed on Feb. 3, 2023, and is based on Japanese Patent Applications No. 2021-195944, filed on Dec. 2, 2021, and No. 2021-199023, filed on Dec. 8, 2021, the entire contents of which are incorporated herein by reference.

### TECHNICAL FIELD

The present disclosure relates to a fastening structure and an aluminum wiring member.

### BACKGROUND

Aluminum is frequently used for electric wires, bus bars, electrodes, and the like because aluminum is a lightweight metal with good electrical conduction and is relatively inexpensive. However, since aluminum is highly reactive with oxygen, an oxide film with a thickness of about 10 nm is formed on a surface of aluminum. Therefore, in the case of pressurized contact, it is known that a contact resistance of copper and nickel, in addition to the contact resistance of precious metals such as gold and silver, is generally from about several μΩ to about several 10 μΩ, while the contact resistance of aluminum is 100 μΩ or more, which is an order of magnitude or more higher. Therefore, when aluminum or an aluminum alloy is used as an electrical conductor, a plating treatment is generally performed to reduce the influence of an oxide film on a surface.

Specifically, in bolt fastening, when a bus bar made of aluminum is used as a fastened member, a surface treatment such as a plating treatment is performed to reduce the contact resistance of aluminum. Japanese Unexamined Patent Application Publication No. 2014-002977 discloses that a conductive member is electrically connected to an electric member made of aluminum or an aluminum alloy by being in pressurized contact with the electric member, and by forming a tin plating layer on a contact surface with the electric member with barrier metal or an alloy layer therebetween, the contact resistance is reduced.

### SUMMARY OF THE INVENTION

However, the method for reducing the contact resistance of aluminum disclosed in Japanese Unexamined Patent Application Publication No. 2014-002977 has a problem that the plating process is complicated and the manufacturing cost increases. In addition, from the viewpoint of recycling, it is desirable to use aluminum as an electrical conductor without applying a plating treatment to aluminum.

The present disclosure has been devised in view of the above problems of the prior art. An object of the present disclosure is to provide a fastening structure and an aluminum wiring member which can reduce the contact resistance of aluminum without performing a plating treatment thereto even when aluminum is used as a fastened member.

A fastening structure according to a first aspect of the present disclosure includes: a first fastened member containing pure aluminum or an aluminum alloy; a second fastened member containing metal; and a fastening member that fastens and fixes the first fastened member and the second fastened member to each other. A protrusion is integrally formed on a surface of the first fastened member facing the second fastened member, the protrusion containing pure aluminum or an aluminum alloy and protruding toward the second fastened member. The pure aluminum or the aluminum alloy in the protrusion on the first fastened member is in direct contact with the metal in the second fastened member.

An aluminum wiring member according to a second aspect of the present disclosure includes the fastening structure described above.

According to the present disclosure, it is possible to provide a fastening structure and an aluminum wiring member which can reduce the contact resistance of aluminum without performing a plating treatment thereto even when aluminum is used as a fastened member.

### BRIEF DESCRIPTION OF DRAWINGS

FIG. 1 is a schematic diagram showing an example of a fastening structure.

FIG. 2 is a diagram showing spring models of a bolt as a fastening member and a bus bar and a terminal as fastened members.

FIG. 3 is a schematic diagram for explaining variation in axial force, repulsive force between a bolt head and a second fastened member, and repulsive force between a first fastened member and the second fastened member when a high temperature state and a low temperature state are repeated in a fastening structure.

FIG. 4 is a graph showing an example of variation in the electrical resistance between a terminal and a bus bar when the fastening torque is varied in a fastening structure using a bolt and a nut as fastening members and the terminal and the bus bar as fastened members.

FIG. 5A is a schematic cross sectional view showing the state of an interface between a first fastened member and a second fastened member in a fastening structure according to the present embodiment before the first fastened member and the second fastened member are fastened.

FIG. 5B is a schematic cross sectional view showing the state of an interface between the first fastened member and the second fastened member in the fastening structure according to the present embodiment after the first fastened member and the second fastened member are fastened.

FIG. 6A is a plan view schematically showing an example of the arrangement of protrusions on the first fastened member in the fastening structure according to the present embodiment.

FIG. 6B is a plan view schematically showing another example of the arrangement of protrusions on the first fastened member in the fastening structure according to the present embodiment.

FIG. 6C is a plan view schematically showing still another example of the arrangement of protrusions on the first fastened member in the fastening structure according to the present embodiment.

FIG. 7 is a plan view showing the shape and size of a terminal and a bus bar used in a reference example.

FIG. 8 is a front view and a plan view showing the shape and size of a fastening structure constituted by the terminal, the bus bar, a bolt, and a nut used in the reference example.

FIG. 9 is a plan view showing a state in which a power supply and a voltmeter are connected to the fastening structure of the reference example.

FIG. 10A is a graph showing the relationship among the electrical resistance of a fastening structure, the temperature in a chamber, and the test time when a thermal shock test from 0 to 20 cycles was performed on samples 1 and 2 of the reference example.

FIG. 10B is a graph showing the relationship among the electrical resistance of the fastening structure, the temperature in the chamber, and the test time when a thermal shock test from 180 to 200 cycles was performed on the samples 1 and 2 of the reference example.

FIG. 11A is a graph showing the relationship among the electrical resistance of the fastening structure, the temperature in the chamber, and the test time when a thermal shock test from 0 to 20 cycles was performed on samples 3 and 4 of the reference example.

FIG. 11B is a graph showing the relationship among the electrical resistance of the fastening structure, the temperature in the chamber, and the test time when a thermal shock test from 180 to 200 cycles was performed on the samples 3 and 4 of the reference example.

FIG. 12 shows photographs indicating results of measuring the height of irregularities on front and rear surfaces of a copper alloy terminal before a fastening structure is fabricated in the samples 1 and 2 in the reference example.

FIG. 13 shows photographs indicating results of measuring the height of surface irregularities of a copper alloy terminal in a fastening structure that is disassembled after being fabricated in the samples 1 and 2 in the reference example. Further, FIG. 13 shows photographs indicating results of measuring the height of surface irregularities of a copper alloy terminal in a disassembled fastening structure that has been subjected to a thermal shock test.

FIG. 14 shows a photograph indicating results of measuring the height of irregularities of a surface of an aluminum alloy terminal before a fastening structure is fabricated in the samples 3 and 4 in the reference example.

FIG. 15 shows photographs indicating results of measuring the height of irregularities of a surface of an aluminum alloy terminal in a fastening structure that is disassembled after being fabricated in the samples 3 and 4 of the reference example. Further, FIG. 15 shows photographs indicating results of measuring the height of irregularities of a surface of an aluminum alloy terminal in a disassembled fastening structure that has been subjected to a thermal shock test.

FIG. 16 is a schematic diagram for explaining samples of an example and a test method.

FIG. 17A is a graph showing the relationship between a contact load on a contact member and a contact resistance in sample 5 of the example.

FIG. 17B is a graph showing the relationship between a contact load on a contact member and a contact resistance in sample 6 of the example.

FIG. 17C is a graph showing the relationship between a contact load on a contact member and a contact resistance in sample 7 of the example.

FIG. 18 shows photographs indicating results of observing a protrusion using a scanning electron microscope-energy dispersive X-ray spectroscopy (SEM-EDX) in the samples 5 and 6 of the example.

### DETAILED DESCRIPTION OF THE INVENTION

Hereafter, a fastening structure and an aluminum wiring member including the fastening structure according to the present embodiment will be described in detail with reference to the drawings. Note that the dimensional ratios in the drawings are exaggerated for illustrative purposes and may differ from the actual ratios.

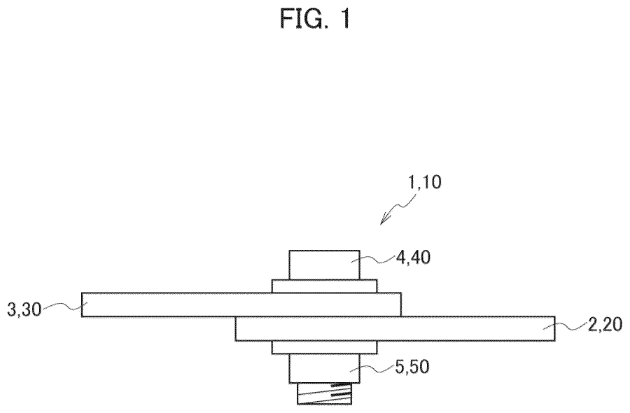

As shown in FIG. 1, a conventional fastening structure 1 includes a first fastened member 2, a second fastened member 3, and a fastening member for fastening and fixing the first fastened member 2 and the second fastened member 3 to each other. A bus bar can be used as the first fastened member 2, a terminal can be used as the second fastened member 3, and a bolt 4 and a nut 5 can be used as the fastening member. The first fastened member 2 and the second fastened member 3 are fastened and fixed by screwing the nut 5 to a threaded portion of the bolt 4, while the threaded portion is inserted into holes disposed in the first fastened member 2 and the second fastened member 3.

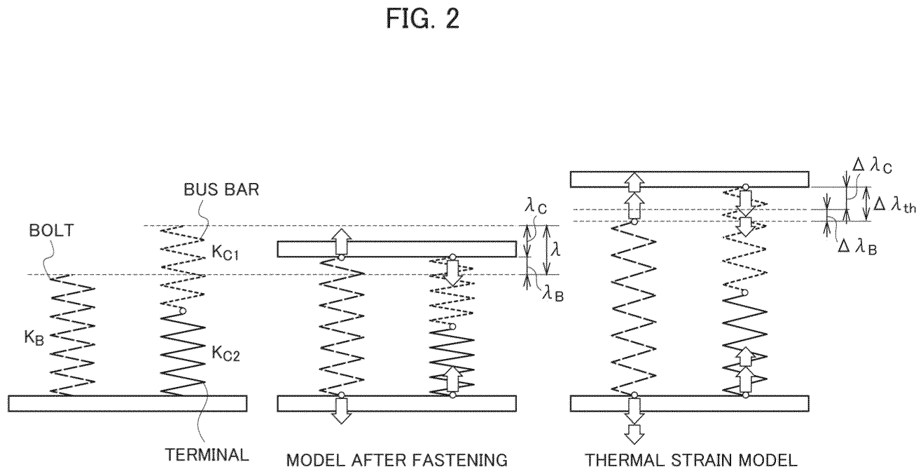

The first fastened member 2, the second fastened member 3, and the fastening member are generally made of a metal material, which expands due to an increase in a temperature and shrinks due to a decrease in a temperature. Therefore, by considering the bolt 4, the bus bar (first fastened member 2), and the terminal (second fastened member 3) as springs as shown in FIG. 2, it is possible to calculate variation in the axial force of the bolt caused by the difference in thermal expansion coefficients of the bolt, the bus bar, and the terminal.

Specifically, an aluminum alloy or steel is used as a material of the bolt 4 and the nut 5, an aluminum alloy or a copper alloy is used as a material of a terminal 3, and an aluminum alloy or a copper alloy is used as a material of a bus bar 2. For the aluminum alloy, A6101-T6 standardized by the Japanese Industrial Standards JIS H4000 is used, and for the copper alloy, C1020-1/2H standardized by JIS H3100 is used. It is assumed that the thickness of the bus bar is 2 mm, the thickness of the copper terminal is 0.8 mm, and the thickness of the aluminum terminal is 2 mm. A condition is set in which the bus bar and the terminal are not subjected to a plating treatment. Further, an M6 bolt is used as the bolt 4.

In the fastening structure 1 in which the bus bar 2 and the terminal 3 are fastened with the fastening torque of 8 N·m using the bolt 4 and the nut 5, the axial force variation of the bolt 4 at 160° C. and −40° C. was calculated from mathematical formula 1. The axial force variation is a variation value from the axial force at 25° C. Table 1 collectively shows the materials of the bolt, nut, terminal, and bus bar, and calculation results of the axial force variation at 160° C. and −40° C. When the axial force variation was calculated, a linear expansion coefficient of iron (Fe) was 11.8*10⁻⁶ K, a linear expansion coefficient of copper (Cu) was 17.1*10⁻⁶ K, and a linear expansion coefficient of aluminum (Al) was 25.6*10⁻⁶ K.

$$Δ {F}_{th} = Z Δ {λ}_{th} \qquad [ Mathematical formula 1 ]$$

$$Z = \frac{{K}_{B} {K}_{C}}{{K}_{B} + {K}_{C}}$$

$$Δ {λ}_{th} = Δ T [ {α}_{B} {l}_{B} - ( {α}_{C 1} {l}_{C 1} + {α}_{C 2} {l}_{C 2} ) ]$$

ΔFₜₕ: axial force variation of bolt, α_{B}: linear expansion coefficient of bolt material, α_{C1}: linear expansion coefficient of bus bar material, α_{C2}: linear expansion coefficient of terminal material, I_{B}: grip length of bolt, I_{C1}: thickness of bus bar, I_{C2}: thickness of terminal, K_{B}: spring constant of bolt, K_{C1}: spring constant of bus bar, K_{C2}: spring constant of terminal

The spring constants K_{B} and K_{C} were calculated from the Young's modulus of the materials and the shapes of the bolt and the bus bar.

TABLE 1

| | | | Axial | Axial |
|---|---|---|---|---|
| | Terminal | Bus bar | force | force |
| | (thickness: | (thickness: | variation | variation |
| Bolt/nut | 0.8 mm) | 2 mm) | (160° C.) | (−40° C.) |
| Aluminum alloy | A6101-T6^{※1} | A6101-T6 | 0 (N) | 0 (N) |
| Steel | C1020-1/2H | C1020-1/2H | 1157 (N) | −557 (N) |
| Steel | C1020-1/2H | A6101-T6 | 2353 (N) | −1133 (N) |
| Steel | A6101-T^{※1} | A6101-T6 | 3159 (N) | −1521 (N) |

^{※1}Thickness of A6101-T6 is 2.0 mm.

Table 1 reveals that, when all of the bolt, nut, terminal, and bus bar are made of aluminum alloy, since linear expansion coefficients thereof are the same, even if the temperature changes from 160° C. to −40° C., there is no variation in the axial force. In contrast, if the bolt and nut are made of steel and the terminal and bus bar are made of copper alloys, the axial force at 160° C. increases by 1157 N and the axial force at −40° C. decreases by 557 N. Similarly, when the bolt and nut are made of steel, the terminal is made of a copper alloy, and the bus bar is made of an aluminum alloy also, the axial force at 160° C. increases and the axial force at −40° C. decreases. Further, when the bolt and nut are made of steel, and the terminal and bus bar are made of aluminum alloy also, the axial force at 160° C. increases and the axial force at −40° C. decreases. In this way, when the materials of the fastening members (bolt and nut) and the fastened members (terminal and bus bar) are different, the axial force largely varies due to the difference in thermal expansion of each material. This kind of variation in the axial force (fastening force) leads to loosening of the bolt and variation in the electrical resistance between the fastened members.

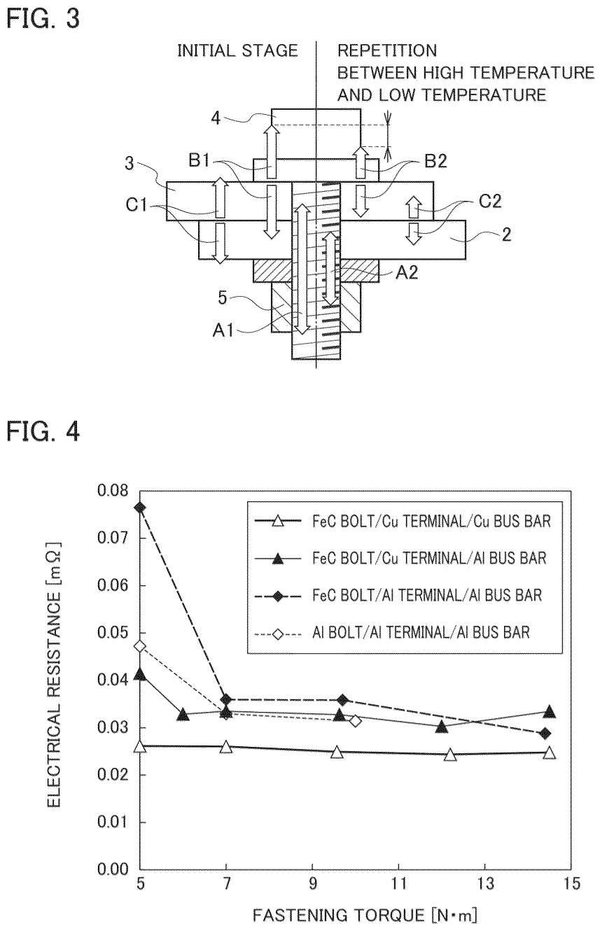

As described above, when a use condition of the fastening structure in which the materials of the fastening members and the fastened members are different is repeated between a high-temperature environment and a low-temperature environment, the axial force of the fastening members largely varies due to the difference in thermal expansion of each material. When this kind of axial force variation of the fastening members is repeated, a phenomenon occurs in which stress reduction occurs in the fastened members, and the axial force, repulsive force between a head of the bolt and the second fastened member 3, and repulsive force between the first fastened member 2 and the second fastened member 3 decrease. In other words, as shown in FIG. 3, in an initial stage before the repetition between the high-temperature environment (160° C.) and the low-temperature environment (−40° C.), axial force A1, repulsive force B1 between the head of the bolt 4 and the second fastened member 3, and repulsive force C1 between the first fastened member 2 and the second fastened member 3 are maintained in a high state. Meanwhile, if the repetition is made between the high-temperature environment and the low-temperature environment, for example, the stress reduction occurs in the second fastened member 3. This causes a phenomenon in which axial force A2, repulsive force B2 between the head of the bolt 4 and the second fastened member 3, and repulsive force C2 between the first fastened member 2 and the second fastened member 3 are reduced to balance the forces in the fastening structure. As a result, the axial force (fastening force) of the bolt 4 relative to the first fastened member 2 and the second fastened member 3 decreases. The stress reduction occurs not only between the head of the bolt 4 and the second fastened member 3, but also between the nut 5 and the first fastened member 2.

The graph in FIG. 4 shows an example of variation in the electrical resistance between a terminal and a bus bar when the fastening torque is varied in a fastening structure using a bolt and a nut as fastening members and the terminal and the bus bar as fastened members. In FIG. 4, steel or an aluminum alloy is used as a material of the bolt and the nut, a copper alloy or an aluminum alloy is used as a material of the terminal, and a copper alloy or an aluminum alloy is used as a material of the bus bar. A6101-T6 is used as the aluminum alloy, and C1020-1/2H is used as the copper alloy. Further, it is assumed that the thickness of the bus bar is 2 mm, the thickness of the copper terminal is 0.8 mm, and the thickness of the aluminum terminal is 2 mm.

As shown in FIG. 4, in a fastening structure constituted by a steel bolt, a copper alloy terminal, and an aluminum alloy bus bar (FeC bolt/Cu terminal/Al bus bar), a fastening structure constituted by a steel bolt, an aluminum alloy terminal, and an aluminum alloy bus bar (FeC bolt/Al terminal/Al bus bar), and a fastening structure constituted by an aluminum alloy bolt, an aluminum alloy terminal, and an aluminum alloy bus bar (Al bolt/Al terminal/Al bus bar), it can be seen that the electrical resistance between fastened members tends to increase as the fastening torque to a bolt decreases. In contrast, in a fastening structure constituted by a steel bolt, a copper alloy terminal, and a copper alloy bus bar (FeC bolt/Cu terminal/Cu bus bar), it can be seen that the electrical resistance does not largely change even if the fastening torque decreases. In other words, when pure aluminum or an aluminum alloy is used as a fastened member, the electrical resistance between fastened members tends to increase as the fastening torque to a bolt decreases.

In this way, when fastening members and fastened members are made of different materials, fastening force (axial force) largely varies due to the difference in thermal expansion of each material, and a decrease in fastening force also occurs due to the stress reduction of fastened members. Further, if aluminum alloy is used for fastened members, the electrical resistance between the fastened members increases as fastening force decreases. With respect to the electrical resistance of a fastening structure, the electrical resistance between fastened members is more dominant than the electrical resistance between a fastening member and a fastened member. Therefore, even when fastening force of a fastening member decreases, it is important to reduce the electrical resistance between fastened members as much as possible in terms of reducing the electrical resistance of an entire fastening structure.

The fastening structure according to the embodiments of the present disclosure is configured to be able to be achieve a reduction in the electrical resistance between fastened members even when pure aluminum or aluminum alloy is used for the fastened members.

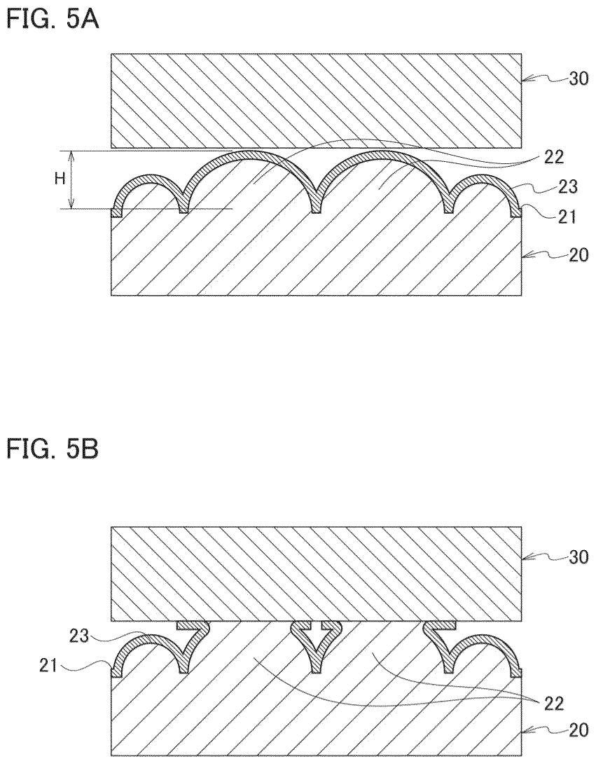

As shown in FIG. 1, a fastening structure 10 according to the present embodiment includes a first fastened member 20 containing pure aluminum or an aluminum alloy, a second fastened member 30 containing metal, and a fastening member for fastening and fixing the first fastened member 20 and the second fastened member 30 to each other. Further, as shown in FIG. 5A, the fastening structure 10 has protrusions 22 integrally formed on a surface 21 of the first fastened member 20 facing the second fastened member 30. While a threaded portion of a bolt 40 serving as a fastening member is inserted into a hole of each of the first fastened member 2 and the second fastened member 30, by screwing a nut 50 to the threaded portion, the first fastened member 2 and the second fastened member 30 are fastened and fixed.

The first fastened member 20 is an electrical conductive member containing pure aluminum or an aluminum alloy as a main component. Further, the first fastened member 20 may be a member made of pure aluminum or an aluminum alloy. The aluminum alloy may contain at least one element selected from the group consisting of Si, Fe, Cu, Mn, Mg, Cr, Zn, and Ti in addition to raw material aluminum such as an aluminum ingot. The aluminum alloy may contain at least one element selected from the group consisting of Si, Fe, Cu, Mn, Mg, Cr, Zn, and Ti, and remainders may be aluminum and unavoidable impurities.

As the aluminum ingot, it is preferable to use pure aluminum having a purity of 99.7% by mass or more. Examples of the aluminum ingot include, among pure aluminum ingots specified in JIS H2102:2011 (aluminum ingot), an aluminum ingot of Class 1 having a purity of 99.7% by mass, an aluminum ingot of Special Class 2 having a purity of 99.85% by mass or more, and an aluminum ingot of Special Class 1 having a purity of 99.90% by mass or more. The present embodiment may use not only an expensive aluminum ingot of Special Class 1 or 2 with higher purity, but also a relatively inexpensive aluminum ingot of Class 1 as the aluminum ingot.

The amount of Si contained in the aluminum alloy is 0.1% by mass or more and less than 1.2% by mass, and preferably from 0.3 to 0.7% by mass. The amount of Fe contained in the aluminum alloy is 0.1% by mass or more and less than 1.7% by mass, and preferably from 0.4 to 0.7% by mass.

The amount of Cu contained in the aluminum alloy is from 0.04 to 7% by mass and preferably from 0.1 to 2.6% by mass. The amount of Mn contained in the aluminum alloy is from 0.03 to 0.8% by mass and preferably from 0.03 to 0.1% by mass. The amount of Mg contained in the aluminum alloy is from 0.03 to 4.5% by mass and preferably from 0.35 to 0.8% by mass. The amount of Cr contained in the aluminum alloy is from 0.03 to 0.35% by mass and preferably from 0.03 to 0.1% by mass. The amount of Zn contained in the aluminum alloy is from 0.04 to 7.0% by mass and preferably from 0.1 to 0.25% by mass. The amount of Ti contained in the aluminum alloy is from 0.00 to 0.2% by mass and preferably from 0.00 to 0.1% by mass.

Aluminum may contain very small amounts of unavoidable impurities. Examples of the unavoidable impurities that may be contained in aluminum include nickel (Ni), rubidium (Rb), tin (Sn), vanadium (V), gallium (Ga), boron (B), sodium (Na), zirconium (Zr), and the like. These are included unavoidably to the extent that the effects of the present embodiment are not inhibited and the properties of the aluminum alloy of the present embodiment are not particularly affected. In addition, elements contained in advance in an aluminum ingot used are also included in the unavoidable impurities. The total amount of unavoidable impurities in the aluminum alloy is preferably 0.07% by mass or less and more preferably 0.05% by mass or less.

Although there are no particular limitations on the shape of the first fastened member 20, for example, the member can be formed in a planar shape. Further, the first fastened member 20 is preferably a bus bar.

The second fastened member 30 is an electrical conductive member containing metal as a main component. Further, the second fastened member 30 may be a member made of the metal. The metal constituting the second fastened member 30 may be pure copper, a copper alloy, pure aluminum, or an aluminum alloy. The aluminum alloy in the first fastened member 20 described above may be used as the aluminum alloy.

Although there are no particular limitations on the shape of the second fastened member 30, for example, the member may be formed in a planar shape. Further, the second fastened member 30 is preferably a bus bar or a terminal.

Fastening members can fasten the first fastened member 20 and the second fastened member 30 by applying appropriate fastening force (compression force) to the members. As these kinds of fastening members, the bolt 40 and the nut 50 shown in FIG. 1 can be used. However, members other than the bolt 40 and the nut 50 can be used as the fastening members as long as the members can apply appropriate fastening force to the first fastened member 20 and the second fastened member 30.

Here, in the fastening structure 10, the protrusions 22 protruding toward the second fastened member 30 are integrally formed on the surface 21 of the first fastened member 20 facing the second fastened member 30. The protrusions 22 have the same metal composition as the first fastened member 20 and contain pure aluminum or aluminum alloy. The pure aluminum or the aluminum alloy contained in the protrusions 22 of the first fastened member 20 is in direct contact with metal of the second fastened member 30. This makes it possible to enhance the electric conductivity between the protrusions 22 of the first fastened member 20 and the second fastened member 30.

FIG. 5A schematically shows the state of an interface between the first fastened member 20 and the second fastened member 30 before the first fastened member 20 and the second fastened member 30 are fastened by using fastening members. Further, FIG. 5B schematically shows the state of an interface between the first fastened member 20 and the second fastened member 30 after the first fastened member 20 and the second fastened member 30 are fastened using fastening members. As shown in FIG. 5A, before the first fastened member 20 and the second fastened member 30 are fastened using fastening members, the plurality of protrusions 22 protruding toward the second fastened member 30 are disposed on the surface 21 of the first fastened member 20. The first fastened member 20 and the protrusions 22 contain pure aluminum or aluminum alloy, and therefore an oxide film 23 is formed on the surface thereof.

In this way, when the first fastened member 20 and the second fastened member 30 are fastened using fastening members and compression force is applied thereto, the protrusions 22 come into contact with a surface of the second fastened member 30 and are deformed plastically, and therefore, the oxide film 23 on the surface of the protrusions 22 is broken. As a result, as shown in FIG. 5B, pure aluminum or aluminum alloy in the protrusions 22 directly contacts and adheres to metal of the second fastened member 30. In other words, the protrusions 22 of the first fastened member 20 and the second fastened member 30 come into direct contact with each other without interposing the oxide film 23 therebetween. Therefore, even when fastening force largely varies due to the difference in thermal expansion of fastening members, the first fastened member 20, and the second fastened member 30, or fastening force decreases due to stress reduction, since the protrusions 22 and the second fastened member 30 are adhered, electrical conduction is ensured. As a result, the electric conductivity between the first fastened member 20 and the second fastened member 30 can be maintained in a high state.

There are no particular limitations on the height H of the protrusions 22 before the first fastened member 20 and the second fastened member 30 are fastened by using fastening members as long as the protrusions 22 and the second fastened member 30 can be adhered. The lower limit of the height H of the protrusions 22 before the members are fastened is preferably 5 μm, more preferably 20 μm, even more preferably 50 μm, and particularly preferably 100 μm. The upper limit of the height H of the protrusions 22 before the members are fastened is preferably 1 mm, more preferably 800 μm, even more preferably 500 μm, and particularly preferably 200 μm.

There are also no particular limitations on the shape of the protrusions 22 before the first fastened member 20 and the second fastened member 30 are fastened using fastening members as long as the protrusions 22 and the second fastened member 30 can be adhered. The shape of the protrusions 22 before the members are fastened can be, for example, a hemispherical shape or a columnar shape.

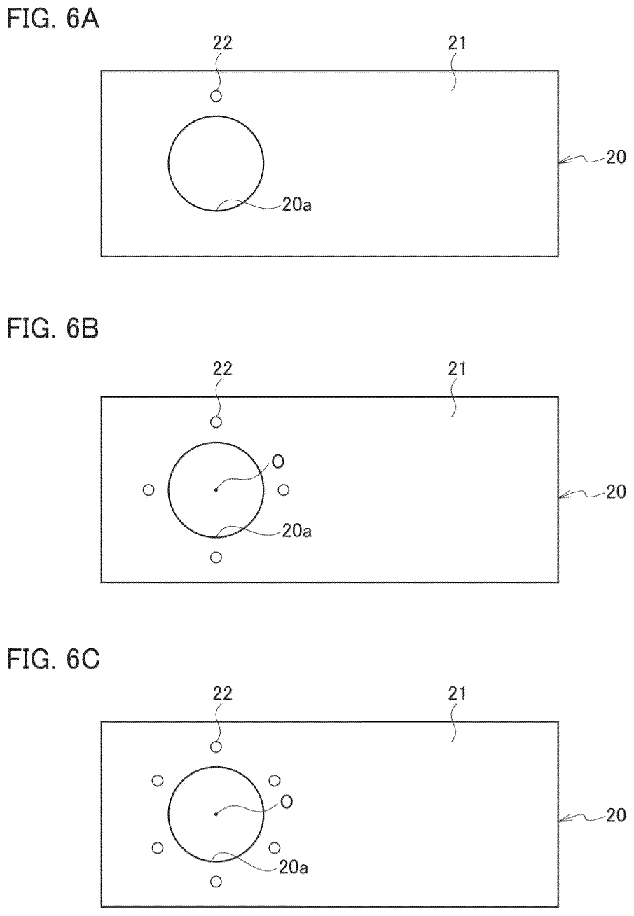

The position of the protrusion 22 of the first fastened member 20 is not particularly limited also. When each of the first fastened member 20 and the second fastened member 30 has a hole through which a fastening member (bolt 40) is inserted, it is preferable that the protrusion 22 of the first fastened member 20 is arranged in a periphery of a hole 20a. As shown in FIGS. 6A to 6C, due to the protrusion 22 being located in a periphery of the hole 20a, compression force when the members are fastened using fastening members efficiently acts on the protrusion 22. Therefore, the breakage of the oxide film 23 and the adhesion of aluminum of the protrusion 22 to the metal of the second fastened member 30 are likely to proceed.

The number of the protrusions 22 of the first fastened member 20 is not particularly limited. As shown in FIG. 6A, the number of the protrusions 22 may be one, or as shown in FIGS. 6B and 6C, the number of the protrusions 22 may be more than one. Due to the plurality of protrusions 22 being provided, it is possible to enhance the electrical conduction between the first fastened member 20 and the second fastened member 30.

Here, when viewed along a lamination direction of the first fastened member 20 and the second fastened member 30 (a longitudinal direction of a threaded portion of a bolt), the hole 20a of each of the first fastened member and the second fastened member has a substantially circular shape, and the plurality of protrusions 22 may be arranged so as to face each other with a center O of the hole therebetween. As shown in FIGS. 6B and 6C, when the plurality of protrusions 22 are arranged so as to face each other with the center O therebetween, compression force from fastening members (the bolt 40 and the nut 50) acts substantially evenly around the hole of each of the first fastened member 20 and the second fastened member 30. This applies fastening force to the first fastened member 20 and the second fastened member 30 in a balanced manner, and therefore it is possible to suppress a decrease in the fastening force.

When viewed along the lamination direction of the first fastened member 20 and the second fastened member 30, it is preferable that the protrusions 22 of the first fastened member 20 are located inside the outer periphery of a seat surface of a head of the bolt 40. As a result, since compression force is easily acted on the protrusions 22, the breakage of the oxide film 23 and the adhesion of aluminum of the protrusions 22 to the metal of the second fastened member 30 are likely to proceed.

It is preferable that the protrusions 22 of the first fastened member 20 satisfy conditions of following mathematical formula 2.

σ_{y}≤F/x≤σᵤₜₛ [Mathematical formula 2]

In mathematical formula 2, σ_{y} is the offset yield strength (N/mm²) of the first fastened member 20, that is, the offset yield strength of the protrusion 22. F is the axial force (N) of a fastening member (bolt 40), and x is the area (mm²) of an initial contact point of the protrusion 22 to the second fastened member 30. The area of the initial contact point can be estimated from the area of the contact point of the protrusion 22 to the second fastened member 30 and the shape of the protrusion 22 measured by disassembling a fastening structure that has been assembled using the first fastened member 20, the second fastened member 30, and fastening members. Outs is the tensile strength (N/mm²) of the first fastened member 20, that is, the tensile strength of the protrusion 22. Due to F/x being equal to or greater than the offset yield strength of the first fastened member 20 and the protrusion 22, the protrusion 22 is plastically deformed during compression, and therefore the oxide film 23 of the protrusion 22 is broken. Therefore, aluminum inside the protrusion 22 can directly contact and adhere to metal of the second fastened member 30. Further, due to F/x being equal to or less than the tensile strength (maximum stress) of the first fastened member 20, it is possible to suppress the occurrence of breakage such as cracks in the protrusion 22 and the first fastened member 20 during compression. The offset yield strength and tensile strength of the first fastened member 20 can be determined in accordance with JIS Z2241 (Metallic materials—Tensile testing—Method of test at room temperature).

As described above, metal of the second fastened member 30 can be pure copper, a copper alloy, pure aluminum, or an aluminum alloy. Here, when metal of the second fastened member 30 is pure aluminum or an aluminum alloy, an oxide film is formed on a surface of the second fastened member 30. However, even if the oxide film is formed on the surface of the second fastened member 30, if compression force is applied, it is possible to break the oxide film on the second fastened member 30 together with the oxide film 23 on the protrusion 22. This adheres aluminum in the protrusion 22 and aluminum in the second fastened member 30, and therefore it is possible to enhance the electric conductivity between the first fastened member 20 and the second fastened member 30.

Next, a method for manufacturing the fastening structure 10 of the present embodiment will be described. When manufacturing the fastening structure 10, first, the first fastened member 20 having the protrusion 22, the second fastened member 30, and fastening members are prepared. As the fastening members, the bolt 40 and the nut 50 can be used as described above.

A method for forming the protrusion 22 on the first fastened member 20 is not particularly limited. For example, by pressing a tool having a recess corresponding to the shape of the protrusion 22 against the surface 21 of the first fastened member 20, the protrusion 22 can be formed on the surface 21. Further, the protrusion 22 can also be formed by making the surface 21 of the first fastened member 20 harsh and roughening the surface.

Next, the first fastened member 20 and the second fastened member 30 are overlapped such that the protrusion 22 faces the second fastened member 30, and then the threaded portion of the bolt 40 is inserted into the hole of each of the first fastened member 2 and the second fastened member 3. The first fastened member 2 and the second fastened member 30 are fastened and fixed by screwing the nut 50 to the threaded portion. In this case, it is preferable to adjust the fastening torque of the bolt 40 such that the relationship of mathematical formula 2 above is satisfied. As a result, aluminum inside the protrusion 22 can directly contact and adhere to metal of the second fastened member 30. In this way, the fastening structure 10 of the present embodiment can be obtained.

In this way, the fastening structure 10 of the present embodiment includes the first fastened member 20 containing pure aluminum or an aluminum alloy, the second fastened member 30 containing metal, and fastening members for fastening and fixing the first fastened member 20 and the second fastened member 30 to each other. The protrusions 22 are integrally formed on the surface 21 of the first fastened member 20 facing the second fastened member 30, the protrusions 22 containing pure aluminum or aluminum alloy and protruding toward the second fastened member 30. The pure aluminum or the aluminum alloy in the protrusions 22 of the first fastened member 20 are in direct contact with the metal of the second fastened member 30. With such a configuration, even when fastening force largely varies due to the difference in thermal expansion of fastening members, the first fastened member 20, and the second fastened member 30, or fastening force decreases due to stress reduction, since the protrusions 22 and the second fastened member 30 are adhered, electrical conduction is ensured. As a result, even when the temperature of the fastening structure 10 largely varies, the electric conductivity between the first fastened member 20 and the second fastened member 30 can be maintained in a high state.

An aluminum wiring member of the present embodiment has the above-described fastening structure. The wiring member is, for example, a member that is arranged in a vehicle and electrically connects each device. An example of this kind of wiring member is a wiring harness. In the fastening structure of the present embodiment, the electrical resistance can be reduced even if a plating treatment is not performed on a surface of a fastened member, and therefore it is possible to suppress an increase in plating cost. In addition, even when the fastening structure is used for a heat generating part near an engine or a battery of an automobile, high electrical conductivity can be maintained, and therefore reliability can be ensured. In addition, when the bolt 40 and the nut 50 are used as fastening members, the fastening members can be easily disassembled, and therefore the separation is easy from the viewpoint of metal recycling.

Although the fastening structure 10 and the aluminum wiring member according to the present embodiment have been described above, the present embodiment is not limited to the above embodiments. In the fastening structure 10 of the present embodiment, at least aluminum of the protrusions 22 of the first fastened member 20 is in direct contact with metal of the second fastened member 30. However, aluminum present inside the surface 21 of the first fastened member 20 may be in direct contact with metal of the second fastened member 30. That is, by breaking the oxide film 23 covering the surface 21 of the first fastened member 20, aluminum inside the surface 21 may be in direct contact with metal of the second fastened member 30 without interposing the oxide film 23 therebetween. This can enhance the electric conductivity between the first fastened member 20 and the second fastened member 30.

In the fastening structure 10 of the present embodiment, the protrusions 22 are formed at least on the first fastened member 20. However, in the fastening structure 10, protrusions may be integrally formed on a surface of the second fastened member 30 facing the first fastened member 20, the protrusions containing the same metal as the second fastened member 30 and protruding toward the first fastened member 20. That is, in the present embodiment, protrusions may also be formed on the surface of the second fastened member 30. Metal of the protrusions of the second fastened member 30 may be in direct contact with pure aluminum or an aluminum alloy in the first fastened member 20. With such a configuration, even when fastening force of a fastening member largely varies or fastening force decreases due to stress reduction, since the protrusions of the second fastened member 30 and the first fastened member 20 are adhered, the electric conductivity can be maintained in a high state.

In the fastening structure 10 of the present embodiment, a fastened member which is not subjected to a plating treatment can be used as the second fastened member 30. However, the second fastened member 30 may be a fastened member having a surface subjected to a tin plating treatment. By performing the tin plating treatment on the surface of the second fastened member 30, it is possible to further enhance the electric conductivity between the protrusions 22 of the first fastened member 20 and the second fastened member 30.

In the present embodiment, a bus bar is used as the first fastened member 20 and a terminal is used as the second fastened member 30, but the present disclosure is not limited to this mode. For example, both of the first fastened member 20 and the second fastened member 30 may be bus bars. That is, in the present embodiment, at least one of the first fastened member 20 or the second fastened member may be a bus bar.

In addition, as described above, the fastening structure 10 of the present embodiment can maintain high electrical conductivity even when stress is reduced. However, for example, by using an aluminum-carbon nanotube composite material having excellent stress reduction resistance and creep properties for a part of the fastening structure, electric conductivity can be further maintained even if stress load increases under a high-temperature environment. Since a change in physical properties of this kind of fastening structure at high temperatures is small, the fastening structure can be used for a heat generating part near an engine or a battery of an automobile, thereby contributing to the weight reduction of components. Further, at least one of a fastening member, the first fastened member 20 or the second fastened member 30 may include dispersion strengthening type aluminum-based composite metal in which particles such as inorganic substances are dispersed in pure aluminum or an aluminum alloy.

### EXAMPLES

The present embodiment will be described in additional detail below by means of an example and a reference example, but the present embodiment is not limited to these examples.

### Reference Example

Fastening structures of samples 1 to 4 were fabricated using terminals, bus bars, bolts, and nuts made of materials shown in Table 2.

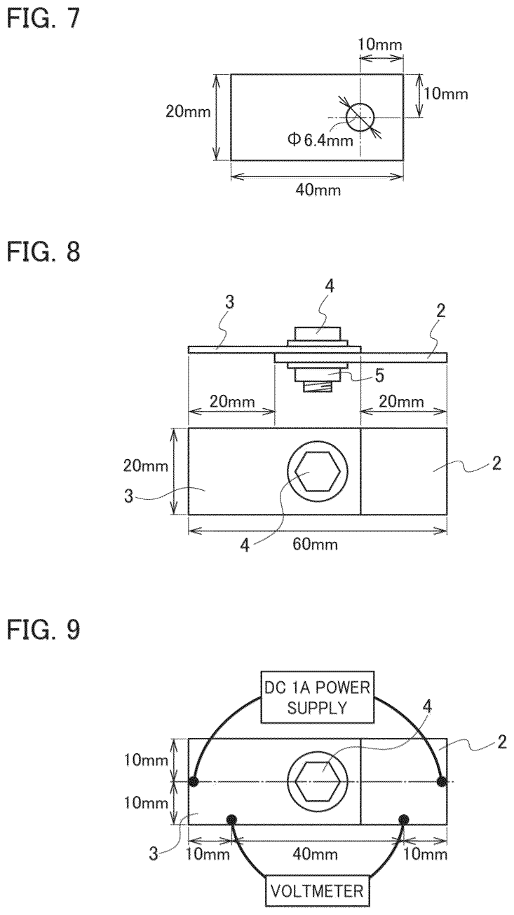

Specifically, first, terminals and a bus bar of size shown in FIG. 7 and Table 3 were fabricated using the materials shown in Table 2. An aluminum alloy was not subjected to a plating treatment. Further, no protrusions was formed on the terminals and bus bar.

In addition, a bolt and a nut made of steel and aluminum alloy were also prepared. As a bolt and a nut made of steel, a bolt and a nut made of wire rods SWRHN12 were used. Table 4 shows the size of a bolt made of steel and an aluminum alloy, and Table 5 shows the size of a nut made of steel and an aluminum alloy.

Next, as shown in FIG. 8, a part of the terminal 3 was laminated on an upper surface of the bus bar 2, and the holes thereof were overlapped. After inserting the threaded portion of the bolt 4 into the holes, the nut 5 was screwed to the threaded portion, and accordingly the first fastened member 2 and the second fastened member 3 were fastened and fixed. The fastening torque of a bolt was adjusted to 8.0 N·m using a direct-reading torque wrench. Next, as shown in FIG. 9, a DC power supply and a voltmeter were electrically connected to a fastening structure of each sample.

TABLE 2

| | Sample 1 | Sample 2 | Sample 3 | Sample 4 |
|---|---|---|---|---|
| Terminal | Copper alloy | Copper alloy | Aluminum alloy | Aluminum alloy |
| | C1020-1/2H | C1020-1/2H | A6101-T6 | A6101-T6 |
| Bus bar | Copper alloy | Aluminum alloy | Aluminum alloy | Aluminum alloy |
| | C1020-1/2H | A6101-T6 | A6101-T6 | A6101-T6 |
| Bolt, Nut | Steel | Steel | Steel | Aluminum alloy |
| | SWRNH12 | SWRNH12 | SWRNH12 | A6056-T6 |
| Fastening torque | 8.0 | 8.0 | 8.0 | 8.0 |
| (N · m) | | | | |
| Resistance value before | 0.0285 | 0.0417 | 0.0491 | 0.0379 |
| thermal shock test (mΩ) | | | | |
| Resistance value after | 0.0277 | 0.1788 | 0.0836 | 0.0376 |
| thermal shock test (mΩ) | | | | |

TABLE 3

| | Thickness | Width | Length | Hole diameter |
|---|---|---|---|---|
| | (mm) | (mm) | (mm) | (mm) |
| Copper alloy terminal | 0.8 | 20 | 40 | 6.4 |
| Aluminum alloy terminal | 2.0 | 20 | 40 | 6.4 |
| Bus bar | 2.0 | 20 | 40 | 6.4 |

TABLE 4

| | | Nominal | Seat surface | Axis length |
|---|---|---|---|---|
| | Material type | diameter (mm) | diameter (mm) | (mm) |
| Bolt | Steel-based | 6 | 13.2 | 9.75 |
| (M6) | Aluminum-based | 6 | 14.0 | 30 |

TABLE 5

| | | Nominal | Seat surface |
|---|---|---|---|
| | Material type | diameter (mm) | diameter (mm) |
| Nut | Steel-based | 6 | 9.8^{※} |
| (M6) | Aluminum-based | 6 | 12.7 |

* Square nut of which one side is 9.8 mm.

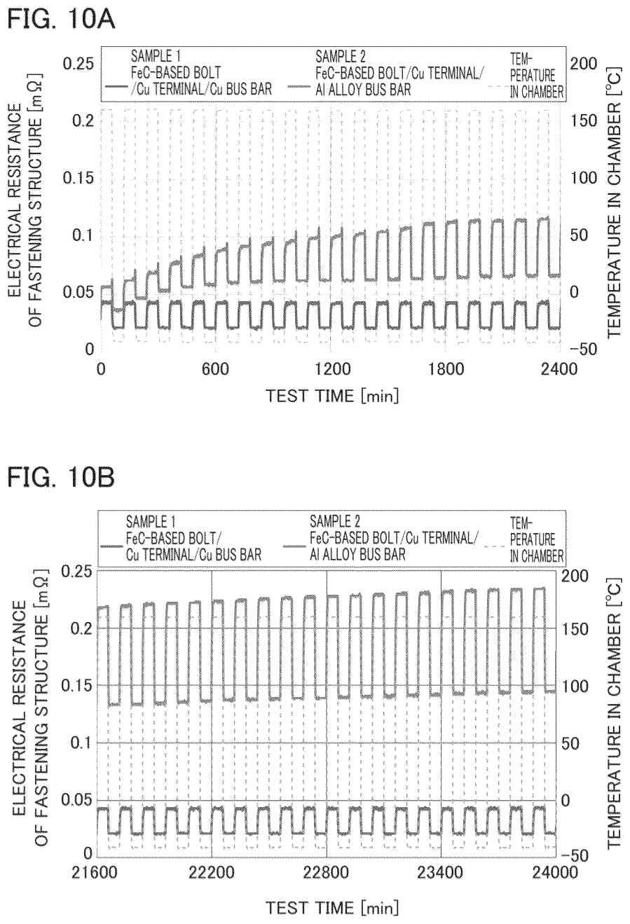

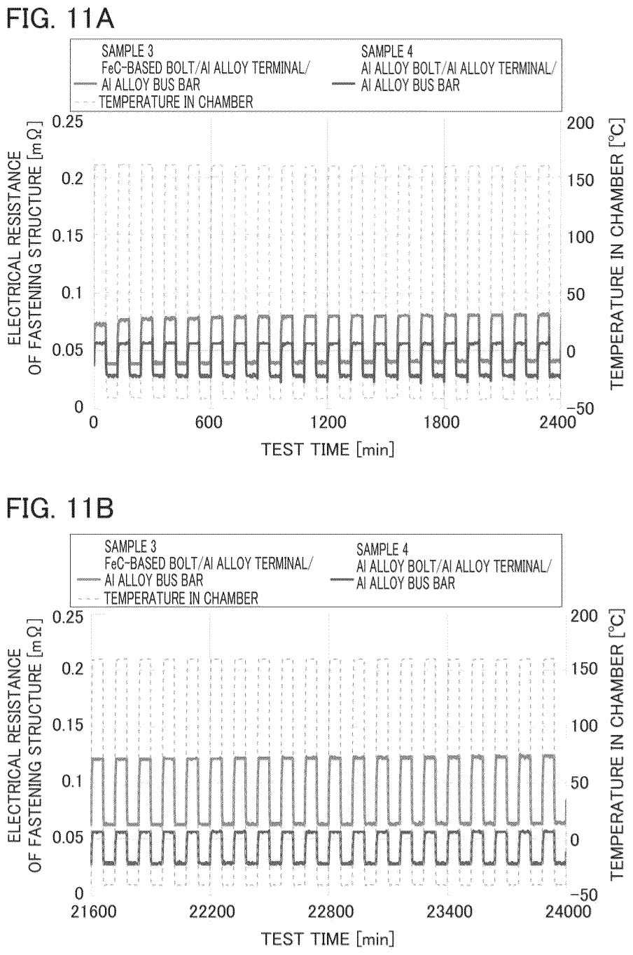

A thermal shock test was performed on a fastening structure of each sample to which a DC power supply and a voltmeter were connected in this way. Specifically, after each sample was placed inside a temperature test chamber, a process of holding each sample in a chamber at 160° C. for 60 minutes and a process of holding each sample in a chamber at −40° C. for 60 minutes were repeated for 200 cycles, and the electrical resistance during the cycles was continuously measured. Measurement conditions of the electrical resistance were set such that a direct current (DC) was 1.0 A, a measurement distance was 40 mm, the measurement accuracy was ±0.02 mV, and the capture time was 1.0 minute. FIGS. 10A and 10B show measurement results of the electrical resistance of sample 1 and sample 2, and FIGS. 11A and 11B show measurement results of the electrical resistance of sample 3 and sample 4. FIGS. 10A and 11A show the change in the electrical resistance from the 0th cycle to the 20th cycle, and FIGS. 10B and 11B show the change in the electrical resistance from the 180th cycle to the 200th cycle. Table 2 shows the electrical resistance of each sample before being subjected to the thermal shock test and the electrical resistance of each sample after being subjected to the thermal shock test.

As shown in FIGS. 10A to 11B, in thermal shock tests performed on all samples, a phenomenon can be observed in which the electrical resistance temporarily increases when the temperature is high and temporarily decreases when the temperature is low. This phenomenon is common for metal. However, FIGS. 10A and 10B and Table 2 reveal that while there is no increase in the electrical resistance of sample 1 even after being subjected to the thermal shock test, the electrical resistance of sample 2 is increased by 3 times or more. In other words, it can be seen that in a case of a fastening structure in which a steel bolt, a copper alloy terminal, and an aluminum alloy bus bar are combined, the electrical resistance of this kind of structure after being subjected to the test significantly increases. Further, as shown in FIG. 10A, it can be confirmed that the electrical resistance of sample 2 increases when the sample is held at 160° C.

Further, FIGS. 11A and 11B and Table 2 reveal that while the electrical resistance of sample 3 after being subjected to the thermal shock test increases by nearly 1.5 times, there is no increase in the electrical resistance of sample 4. In other words, it can be seen that in a case of a fastening structure in which a steel bolt, an aluminum alloy terminal, and an aluminum alloy bus bar are combined, the electrical resistance of this kind of fastening structure after being subjected to the test significantly increases.

Next, the height of surface irregularities of a terminal was measured before a fastening structure of each sample was fabricated, after a fastening structure was fabricated, and after a thermal shock test was performed on a fastening structure. Specifically, using a profile-measuring laser microscopes VK-X1100 manufactured by KEYENCE CORPORATION, the height of irregularities was measured in a range of 15 mm in length and 15 mm in width around a hole.

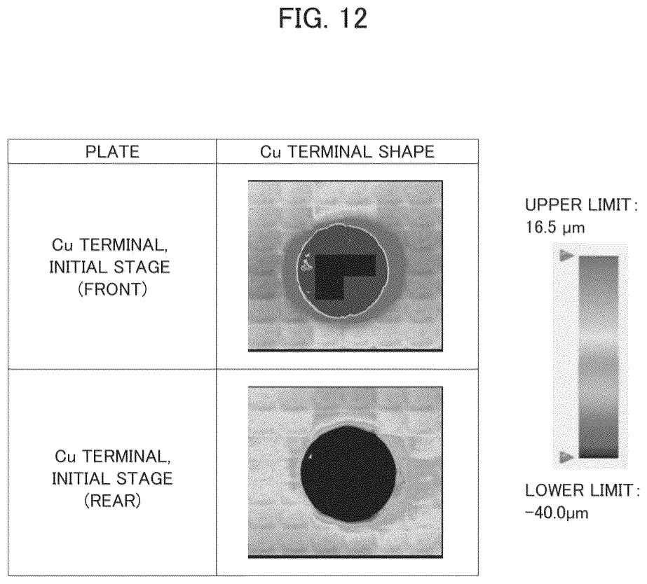

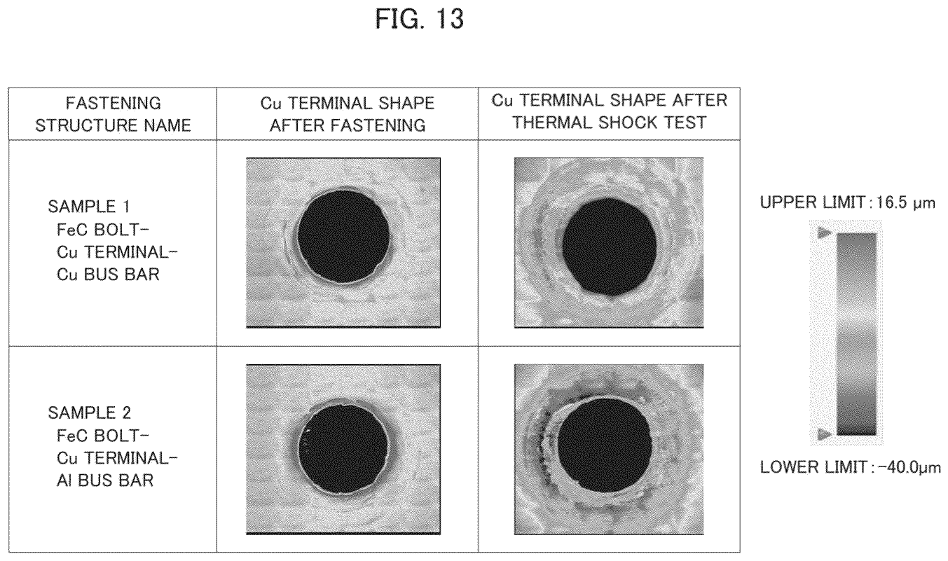

FIG. 12 shows results of measuring the height of irregularities of front and rear surfaces of a copper alloy terminal before a fastening structure is fabricated, that is, before the copper alloy terminal is fastened by using a fastening member. FIG. 13 shows results of measuring the height of surface irregularities of a copper alloy terminal in a fastening structure that is disassembled after being fabricated. Further, FIG. 13 shows results of measuring the height of surface irregularities of a copper alloy terminal in a disassembled fastening structure that has been subjected to a thermal shock test. FIG. 13 shows results of measuring the height of irregularities of a surface of a copper alloy terminal in contact with a seat surface of a bolt head.

From FIGS. 12 and 13, it was observed that a surface of a copper alloy terminal was recessed along a seat surface shape in both of samples 1 and 2 after performing thermal shock tests thereto. In particular, a recess of about 40 μm at a maximum was observed in sample 2. In general, the offset yield strength (yield stress) of a metal material decreases at a high temperature compared with a 25° C. atmosphere. In a 160° C. atmosphere during a thermal shock test, metal expands due to linear expansion, and this leads to an increase in fastening force (axial force). Therefore, it is considered that the stress reduction was accelerated due to the high-temperature environment and the increase in axial force, resulting in plastic deformation.

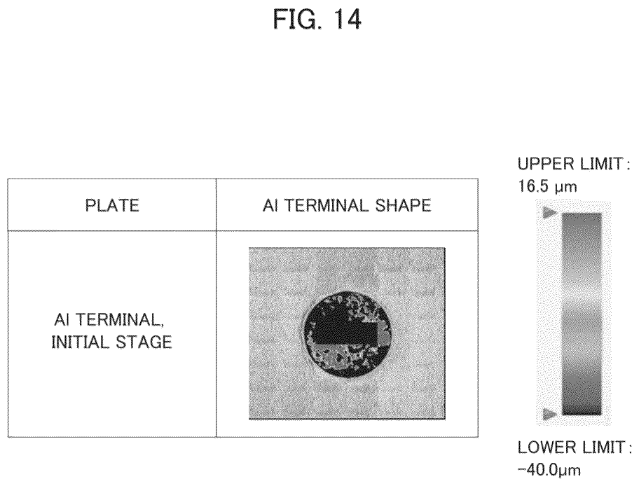

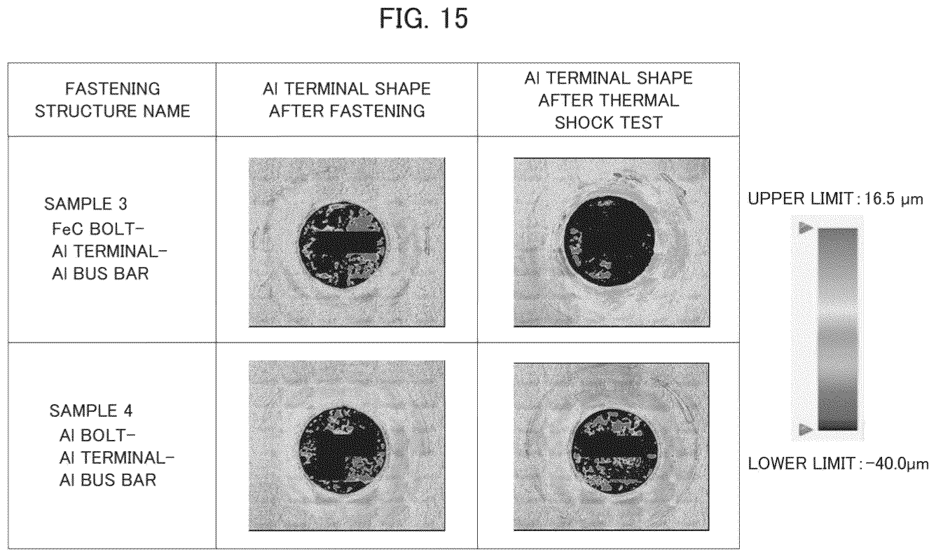

FIG. 14 shows a result of measuring the height of irregularities of a surface of an aluminum alloy terminal before a fastening structure is fabricated, that is, before the aluminum alloy terminal is fastened using a fastening member. FIG. 15 shows a result of measuring the height of irregularities of a surface of an aluminum alloy terminal in a fastening structure that is disassembled after being fabricated. Further, FIG. 15 shows a result of measuring the height of irregularities of the surface of the aluminum alloy terminal in a disassembled fastening structure that has been subjected to a thermal shock test. FIG. 15 shows a result of measuring the height of irregularities of a surface of the aluminum alloy terminal in contact with a seat surface of a bolt head.

From FIGS. 14 and 15, it is observed that a surface of an aluminum alloy terminal is recessed along a seat surface shape in sample 3 after performing a thermal shock test thereto. In this way, in a 160° C. atmosphere during a thermal shock test, metal expands due to linear expansion, and this leads to an increase in fastening force (axial force). It is considered that stress reduction is accelerated due to the high-temperature environment and the increase in the axial force, resulting in plastic deformation. Meanwhile, no recess is observed in a surface of an aluminum alloy terminal in sample 4 even after performing a thermal shock test thereto. In this way, when materials of a bolt, a terminal, and a bus bar are the same, it is considered that little stress reduction has occurred in an aluminum alloy terminal.

Here, as shown in FIG. 4, in a fastening structure constituted by a steel bolt, a copper alloy terminal, and an aluminum alloy bus bar, the electrical resistance between fastened members tends to increase as the fastening torque to a bolt decreases. In a fastening structure (sample 2) in which a steel bolt, a copper alloy terminal, and an aluminum alloy bus bar are combined, the electrical resistance largely increases after performing a thermal shock test, and further, a recess occurs in the copper alloy terminal. In addition, the electrical resistance of sample 2 increases when the sample is held at 160° C. Therefore, it is considered that in the fastening structure in which the steel bolt, the copper alloy terminal, and the aluminum alloy bus bar are combined, the electrical resistance between the terminal and the bus bar increases because axial force (fastening force) of the bolt decreases due to stress reduction when the temperature is high.

Similarly, as shown in FIG. 4, in a fastening structure constituted by a steel bolt, an aluminum alloy terminal, and an aluminum alloy bus bar, the electrical resistance between fastened members tends to increase as the fastening torque to the bolt decreases. In the fastening structure (sample 3) in which the steel bolt, the aluminum alloy terminal, and the aluminum alloy bus bar are combined, the electrical resistance largely increases after performing a thermal shock test, and further, a recess occurs in the aluminum alloy terminal. Therefore, it is considered that even in the fastening structure in which the steel bolt, the aluminum alloy terminal, and the aluminum alloy bus bar are combined, the electrical resistance between the terminal and the bus bar increases because fastening force of the bolt decreases due to stress reduction.

### Example

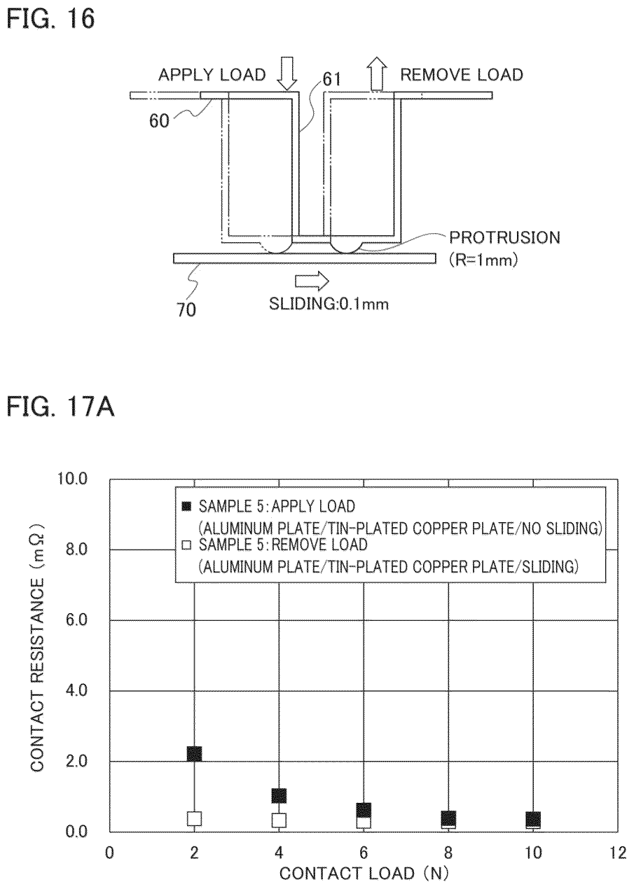

First, a contact member 60 and a contacted plate 70 of samples 5 to 7 shown in FIG. 16 were fabricated using materials shown in Table 6. The contact member 60 is a member in which one hemispherical protrusion is formed at a lower end of a recess 61 in a metal plate. A radius R of the protrusion was 1 mm. The contacted plate 70 is a member made of a metal plate and arranged so as to face the protrusion of the contact member 60.

TABLE 6

| | Sample 5 | Sample 6 | Sample 7 |
|---|---|---|---|
| Contact member | Aluminum alloy | Aluminum alloy | Copper alloy |
| with protrusion | A6101-T6 | A6101-T6 | C1020-1/2H |
| Contacted | Tin-plated copper | Copper alloy | Copper alloy |
| plate | alloy | C1020-1/2H | C1020-1/2H |
| | C1020-1/2H | | |
| Whether there is | Sliding | Sliding | No sliding |
| slidilng | | | |

Next, one terminal of each of a DC power supply and a voltmeter was electrically connected to the contact members 60 of samples 5 and 6, and the other terminal of each of the DC power supply and the voltmeter was electrically connected to the contacted plate 70. Then, as shown in FIG. 16, a predetermined load was applied to the contact members 60 to bring the protrusions into contact with a surface of the contacted plate 70, and the contact resistance between the contact members 60 and the contacted plate 70 was measured. Next, the contact members 60 were slid relative to the contacted plate 70 while a predetermined load is applied to the contact members 60, and then the contact resistance between the contact members 60 and the contacted plate 70 was measured. Next, a load on the contact members 60 was removed to the predetermined load, and the contact resistance between the contact members 60 and the contacted plate 70 was measured.

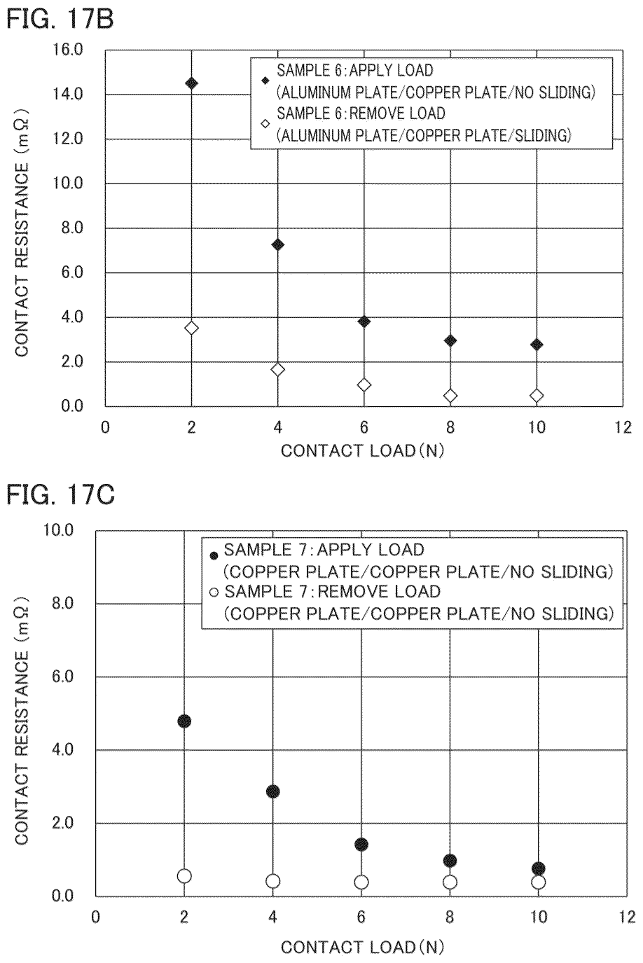

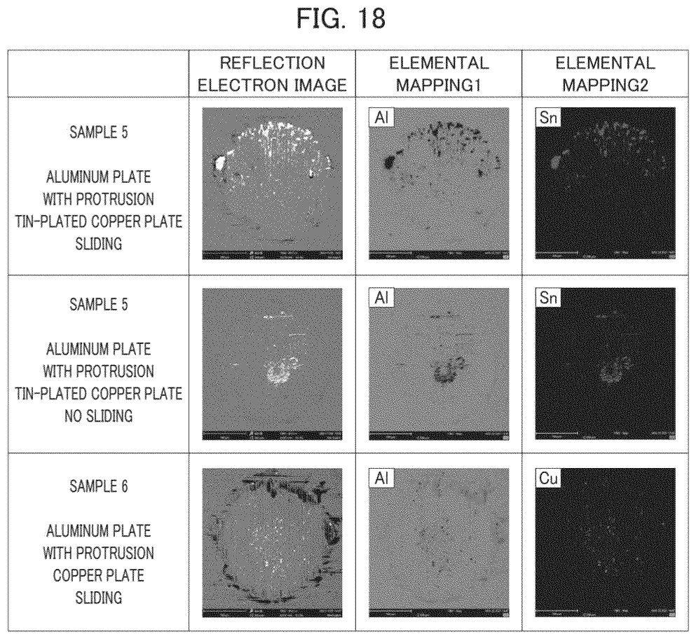

Specifically, first, loads of 2N, 4N, 6N, 8N, and 10N were applied (placed) to the contact member 60 of each sample, and the contact resistance in each load was measured. Next, the contact member 60 was slid 0.1 mm while a load of 10N was applied to the member, and the contact resistance was measured. Finally, the loads were removed to 8N, 6N, 4N, and 2N, and the contact resistance in each load was measured. FIG. 17 shows a relationship between a load on the contact member 60 and the contact resistance in each sample. In FIGS. 17A, 17B, and 17C, filled marks indicate the contact resistance in each load when the load is applied, and blank marks indicate the contact resistance in each load when the load is removed.

For sample 7 also, as for samples 5 and 6, loads of 2N, 4N, 6N, 8N, and 10N were applied (placed) to the contact member 60, and the contact resistance in each load was measured. Next, the contact member 60 was not slid, and the contact resistance when the loads were removed to 8N, 6N, 4N, and 2N was measured.

In sample 7 in which copper alloys were used for the contact member 60 and the contacted plate 70, even if a load on the contact member 60 was removed, the contact resistance was maintained in a low state as shown in FIG. 17C. This result correlates with the result of the fastening structure constituted by the steel bolt, the copper alloy terminal, and the copper alloy bus bar in FIG. 4.

In sample 5 using the contact member 60 made of an aluminum alloy and the contacted plate 70 made of a tin-plated copper alloy, the contact resistance decreases as a load on the contact member 60 increases as shown in FIG. 17A. When the contact member 60 is slid while a load of 10 N is applied thereto, the contact resistance further decreases. After sliding the member, an increase in the contact resistance relative to a decrease in the load is small. In other words, when the contact member 60 is slid while the load is applied thereto, an aluminum oxide film on a surface of a protrusion is broken, the true contact area is increased, and an aluminum alloy in the protrusion and tin in the contacted plate 70 are considered to be adhered. Due to the adhesion between the aluminum alloy in the protrusion and tin in the contacted plate 70 being maintained, it is possible to reduce an increase in the contact resistance between the contact member 60 and the contacted plate 70 even if the load is removed. In this way, due to the adhesion between the aluminum alloy in the protrusion and tin in the contacted plate 70 being accelerated, the contact resistance can be maintained in a low state even when the load varies.

Further, the adhesion of the aluminum alloy can be accelerated even if there is no tin plating on the contacted plate 70. In sample 6 using the contact member 60 made of an aluminum alloy and the contacted plate 70 made of a copper alloy, similar to sample 5, the contact resistance decreases as a load on the contact member 60 increases as shown in FIG. 17B. When the contact member 60 is slid while a load of 10 N is applied thereto, the contact resistance further decreases. After sliding the member, an increase in the contact resistance relative to a decrease in the load is larger compared with that of sample 5, but the contact resistance is maintained in a low state compared to when the load is applied. This suggests that the aluminum alloy in the protrusion and copper in the contacted plate 70 are adhered. Further, due to the adhesion between the aluminum alloy in the protrusion and copper in the contacted plate 70 being maintained, even if the load is removed, it is considered that the contact resistance between the contact member 60 and the contacted plate 70 is maintained in a low state compared to when the load is applied. In this way, due to the adhesion between the aluminum alloy in the protrusion and copper in the contacted plate 70 being accelerated, even if the load varies, the contact resistance can be maintained in a low state.

FIG. 18 shows results of observing the protrusion of the contact member after sliding the contact member in samples 5 and 6 by using the scanning electron microscope-energy dispersive X-ray spectroscopy (SEM-EDX). FIG. 18 also shows results of observing, in sample 5, the contact member 60 which is not slid but is brought into contact with the contacted plate 70 and to which a predetermined load is applied.

As shown in FIG. 18, in sample 5, it can be observed that tin is attached on a surface of the protrusion made of the aluminum alloy. Further, in sample 5, it can be observed that more tin is attached to the protrusion by sliding the contact member 60. From this, it can be seen that the aluminum alloy in the protrusion and tin in the contacted plate 70 are sufficiently adhered by sliding the contact member 60 while applying a load thereto. Since FIG. 17 shows a decrease in the contact resistance of sample 5, it is considered that the contact resistance decreases due to the adhesion between the aluminum alloy in the protrusion and tin in the contacted plate 70.

Similarly, as shown in FIG. 18, in sample 6, it can be observed that copper is attached on a surface of a protrusion made of an aluminum alloy. This reveals that the aluminum alloy in the protrusion and copper in the contacted plate 70 are adhered. Due to the adhesion, as shown in FIG. 17B, the contact resistance of sample 6 when a load is removed shows a lower value than that when a load is applied. That is, it is considered that the contact resistance decreases due to the adhesion between the aluminum alloy in the protrusion and copper in the contacted plate 70.

Although some embodiments of the present disclosure have been described above, these embodiments are presented as examples and are not intended to limit the scope of the present disclosure. These new embodiments can be implemented in various other forms, and various omissions, substitutions, and modifications are possible without deviating from the gist of the present disclosure. These embodiments and variations thereof are included in the scope and gist of the present disclosure, as well as within the disclosure recited in the claims and the range of equivalency.

1. A fastening structure comprising:
a first fastened member containing pure aluminum or an aluminum alloy;
a second fastened member containing metal; and
a fastening member that fastens and fixes the first fastened member and the second fastened member to each other, wherein
a protrusion is integrally formed on a surface of the first fastened member facing the second fastened member, the protrusion containing pure aluminum or an aluminum alloy and protruding toward the second fastened member, and
the pure aluminum or the aluminum alloy in the protrusion on the first fastened member directly contacts and adheres to the metal in the second fastened member.

2. The fastening structure according to claim 1, wherein the metal in the second fastened member is pure copper, a copper alloy, pure aluminum, or an aluminum alloy.

3. The fastening structure according to claim 1, wherein the second fastened member is a fastened member having a surface subjected to a tin plating treatment.

4. The fastening structure according to claim 1, wherein the protrusion on the first fastened member and the second fastened member are in contact with each other without interposing an oxide film therebetween.

5. The fastening structure according to claim 1, wherein each of the first fastened member and the second fastened member includes a hole through which the fastening member is inserted, and
the protrusion is provided in plurality, and the plurality of protrusions on the first fastened member are arranged in a periphery of the hole.

6. The fastening structure according to claim 5, wherein when viewed along a lamination direction of the first fastened member and the second fastened member, the hole of each of the first fastened member and the second fastened member has a substantially circular shape, and
the plurality of protrusions on the first fastened member are arranged to face each other with a center of the hole therebetween.

7. The fastening structure according to claim 1, wherein the protrusion on the first fastened member satisfy a condition of mathematical formula 1 below,
$${σ}_{y} \leq F / x \leq {σ}_{uts} \qquad [ Mathematical formula 1 ]$$
where σ_{y} is offset yield strength (N/mm²) of the first fastened member, F is axial force (N) of the fastening member, x is an area (mm²) of an initial contact point of the protrusion to the second fastened member, and Outs is tensile strength (N/mm²) of the first fastened member.

8. The fastening structure according to claim 1, wherein at least one of the first fastened member or the second fastened member is a bus bar.

9. An aluminum wiring member comprising:
the fastening structure according to claim 1.
